(19) United States
(12) Patent Application Publication
(10) Pub. No.: US 2002/0191159 A1
(43) Pub. Date: Dec. 19, 2002

(54) Projector

(75) Inventors: Shinichi Nagao, Sakai-Shi (JP); Hideki Nagata, Kobe-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/164,687

(22) Filed: Jun. 7, 2002

(30) Foreign Application Priority Data
Jun. 15, 2001 (JP) 2001-181336

(51) Int. Cl. G03B 21/18

(52) U.S. Cl. 353/54

(57) ABSTRACT

A droplet generating apparatus is provided to a projector, so as to cool an optical member utilizing taking away of heat when droplets are vaporized. The droplets generated by the droplet generating apparatus are allowed to adhere directly to the optical member or an air flow is generated to transfer the droplets, so that the droplets are allowed to adhere to the optical member. Moreover, the optical member is cooled by cooling air, and after the droplets are included in the cooling air, the droplets are removed, so that a temperature of the cooling air is previously lowered.

This application is based on application No. 2001-181336 field in Japan, the content of which is hereby incorporated by reference.

### BACKGROUND OF THE INVENTION

1. Field of the Invention

The present invention relates to a projector for emitting a light so as to provide an image, particularly, relates to cooling of the projector or of members composing the projector.

2. Description of the Related Art

Conventionally, a projector is used for presenting an image to a lot of people at one time in a meeting or the like, and a projector that serves also as a television is in practical use. The projector modulates an illumination light so as to form a light presenting an image, and projects this light so as to present the image.

Therefore, the projector has various optical members including a light source for supplying an illumination light, a modulating element for modulating an illumination light, and a projecting optical system for projecting a modulated light.

The optical members of the projector generate heat by concerning themselves with a light and their temperature rises. When the temperature of the optical systems becomes too high, change in quality, deformation and the like occur and the performance is deteriorated, and thus the originally optical function cannot be achieved. Particularly, in a use which requires a bright image, a light amount should be increased, and the temperature rises remarkably, and thus the rise of the temperature cannot be suppressed simply by radiating a heat naturally from the optical members to ambient air.

Therefore, a fan which generates an air flow is provided to the projector, and air is blown over the optical members so that the optical members are forcibly cooled. Since the cooling efficiency depends on a flow rate of the cooling air, as a calorific value of the optical members is larger, a rotational speed of the fan should be heightened or a large fan should be provided.

FIG. 12 schematically shows one example of a structure of the conventional projector in which the fan is provided so as to cool the optical members. This projector 9 which decomposes a white illumination light into a red light, a green light and a blue light, and modulates the decomposed colored lights individually so as to present a colored image; has a light source 91 for supplying an illumination light, three modulation optical systems 93 for modulating the illumination light, an illumination optical system 92 for polarizing the illumination light into a linear polarized light and leading to the modulation optical systems 93 by carrying out color separations, a synthesizing optical system 94 for synthesizing the modulated colored lights, and a projection optical system 95 for projecting the synthesized light.

FIG. 13 schematically shows a periphery of the modulation optical systems 93. The modulation optical system 93 includes a transmission type liquid crystal display panel (LCD panel) 93a, of which two polarizing plates 93b and 93c arranged on the front and rear sides. A linear polarized light is given to the liquid crystal panel 93a, and a polarized surface of the linear polarized light is partially rotated by 90 degrees by a displayed image, so as to modulate the light. The modulated light includes a linear polarized light representing an image and an unnecessary linear polarized light not representing an image.

The polarizing plate 93b arranged on an incident side of the liquid crystal panel 93a absorbs an unnecessary polarized component mixed in the guided light so as to provide only the linear polarized light which conforms to the liquid crystal panel 93a; and the polarizing plate 93c arranged on an emission side removes the unnecessary linear polarized light not presenting the image and provides only the linear polarized light presenting the image as the light which enters the synthesizing optical system 94. The LCD panel 93a and the polarizing plates 93b and 93c generate heats, but since the polarizing plate 93c on the emission side absorbs a lot of light, its temperature becomes particularly high easily.

As shown in FIG. 12, the projector 9 has a power source 96 for supplying an electronic power to the light source 91, a driving section of the LCD panel 93a or the like, and further has a fan 97a for cooling the light source 91 which generates a heat according to light emission and a fan 97b for cooling the modulation optical systems 93 which generate a heat according to modulation.

All the members are housed in a housing 98, and the housing 98 is provided with intake ports 98a and 98b and an exhaust port 98c. The fan 97a is arranged in a vicinity of the light source 91, and inhales external air from the intake port 98a so as to blow the air as cooling air F onto the light source 91. The fan 97b is arranged in a position separated from the modulation optical systems 93, and inhales external air from the intake port 98b so as to blow the air as cooling air F onto the modulation optical systems 93.

The cooling air F of which temperature is raised due to the cooling of the light source 91 and the modulation optical systems 93 is discharged into the outside from the exhaust port 98c. Axial flow fans or scirocco fans are used as the fans 97a and 97b.

The fan 97b is arranged in the position separated from the modulation optical systems 93 since the synthesizing optical system 94 and an end portion of the illumination optical system 92 exist in the vicinity of the modulation optical systems 93, and if a fan having a size enough for generating a sufficient amount of airflow is arranged in the vicinity of the modulation optical systems 93, this causes enlargement of the projector 9. Alternatively, a duct 99 for guiding the airflow generated by the fan 97b concentratively to the modulation optical systems 93 is provided between the fan 97b and the modulation optical systems 93.

FIG. 14 schematically shows a vertical section of the vicinity of the modulation optical system 93. The duct 99 is arranged below the modulation optical systems 93, and the cooling air F generated by the fan 97b flows in gaps between the LCD panel 93a and the polarizing plate 93b and 93c so as to absorb their heats.

It is necessary for functioning the projector suitably to cool the optical members of which temperature rises, but a rotating sound of the fans and a sound of the generated cooling air become noise. Meanwhile, it is not preferable that the projector makes a noise in any use form, and thus the noise is required to be reduced as low as possible. Moreover, the miniaturization of the projector is highly demanded, and this requires the miniaturization or omission of the fans.

### SUMMARY OF THE INVENTION

The present invention is devised in view of these points, and an object is to realize a projector in which cooling efficiency of optical members is heightened so that a noise is low and miniaturization is easily.

In order to achieve the above object, according to one aspect of the present invention, a projector for generating and projecting a light representing an image includes: an apparatus for generating drops (droplets) of a liquid, wherein droplets are allowed to adhere to an optical member of which temperature is raised by concerning itself with a light, so that the optical member is cooled.

This projector cools the optical member by utilizing that when the droplets, which adhere to the optical member, are vaporized, a heat of vaporization is taken away. The heat of vaporization, which is absorbed when a liquid is changed into a gas, is overpoweringly larger than a heat capacity of air. Furthermore, since the droplets are liquid with small diameter and their surface area per volume is large, the state is easy to vaporize, and thus a heat of the optical member is easily taken away.

Moreover, even if some of the droplets are not vaporized and still adhere to the optical member, since the heat capacity of the liquid is larger than the heat capacity of the air, it is possible to take away a heat greatly. Therefore, it is possible to cool the optical member far efficiently than in case of cooling by means of only air.

According to another aspect of the present invention, a projector for generating and projecting a light representing an image, includes an air flow generating apparatus for generating an air flow, wherein the optical member of which temperature is raised by concerning it with a light is cooled by the air flow, and includes a generating apparatus for generating droplets, wherein the droplets are included in the air flow generated by the air flow generating apparatus ,and are removed from the air flow before reaching the optical member.

This projector allows the droplets to be temporarily included in the air flow generated by the air flow generating member in order to cool the optical member, i.e., cooling air so as to previously lower the temperature of the cooling air and heighten the cooling efficiency. Since some of the droplets included in the cooling air are vaporized so that the heat is taken away from the cooling air, the temperature of the cooling air is lowered certainly.

Since the droplets are removed when the cooling air reaches the optical member, the droplets do not adhere to the optical member. Therefore, there is no fear of influence of the droplets on the light, and thus it is suitable for cooling the optical member operates with respect to a light representing an image.

These and other objects, advantages and features of the invention will become apparent from the following description thereof taken in conjunction with the accompanying drawings, which illustrate specific embodiments of the invention.

### BRIEF DESCRIPTION OF THE DRAWINGS

In the following description, like parts are designated by like reference numbers throughout the several drawings.

FIG. 1 is a plan view schematically showing a structure of an optical system of a projector which is one embodiment of the present invention.

FIG. 2 is a plan view schematically showing a structure of a modulation optical system of the projector.

FIG. 3 is a sectional view schematically showing a structure of a droplet generating apparatus provided in the projector.

FIG. 4 is a sectional view schematically showing another structure of the droplet generating apparatus provided in the projector.

FIG. 5 is a sectional view schematically showing still another structure of the droplet generating apparatus provided in the projector.

FIG. 6 is a sectional view schematically showing yet another structure of the droplet generating apparatus provided in the projector.

FIG. 7 is a sectional view schematically showing further another of the structure of the droplet generating apparatus provided in the projector.

FIG. 8 is a sectional view schematically showing a structure for cooling the optical member in the projector.

FIG. 9 is a sectional view schematically showing another structure for cooling the optical member in the projector.

FIG. 10 is a sectional view schematically showing still another structure for cooling the optical member in the projector.

FIG. 11 is a sectional view schematically showing yet another structure for cooling the optical member in the projector.

FIG. 12 is a plan view schematically showing a structure of a conventional projector.

FIG. 13 is a plan view schematically showing a vicinity of a modulation optical system of the conventional projector.

FIG. 14 is a sectional view schematically showing the vicinity of the modulation optical system of the conventional projector.

### DETAILED DESCRIPTION OF THE PREFERRED EMBODIMENTS

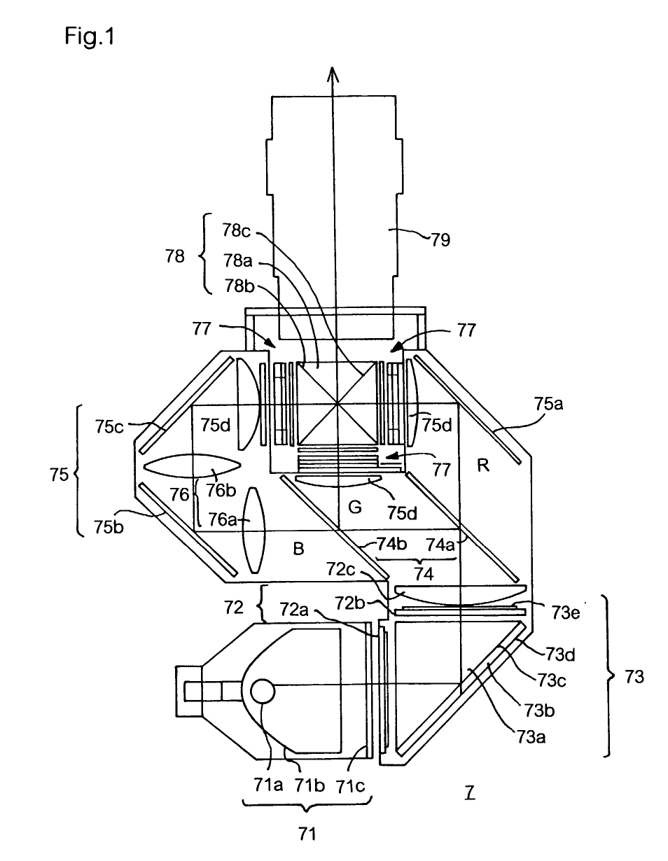

Hereinafter, there will be explained one embodiment of the present invention with reference to the drawings. As sown in FIG. 1, a projector 7 decomposes a white light from a light source 71 into a red (R) light, a green (G) light and a blue (B) light, and modulates the decomposed lights according to an R component, a G component and a B component of an image individually, and synthesizes to project the modulated lights so as to provide a color image.

The light source 71 is composed of a lamp 71a, a reflector 71b and an UV/IR cut filter 71c. The lamp 71a generates a non-polarized light of a wavelength including a whole visible area. The reflector 71b has a paraboloid form and reflects the light generated by the lamp 71a so as to provide a parallel light. Moreover, the UV/IR cut filter 71c removes an infrared radiation and an ultraviolet radiation so as to provide only a visible light.

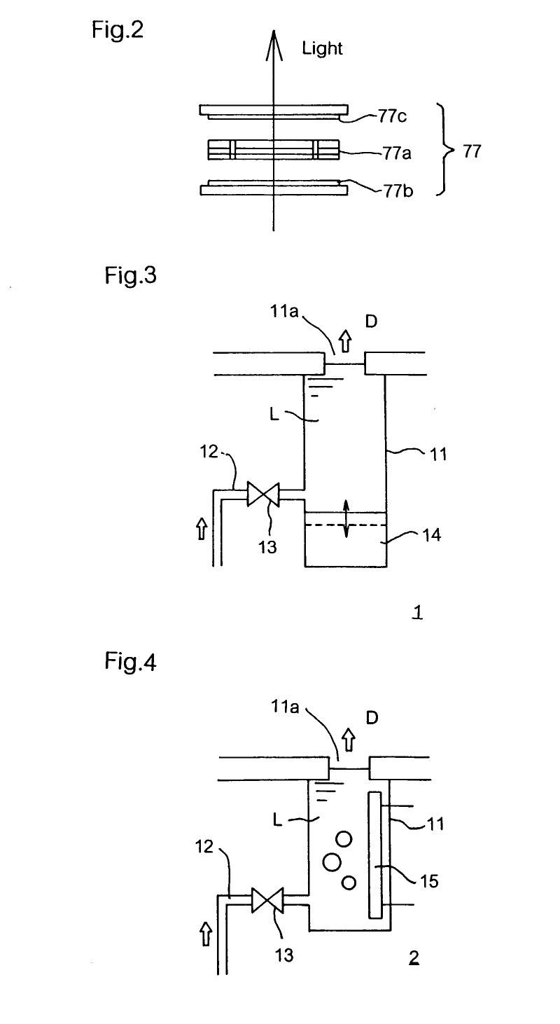

The projector 7 has three modulation optical systems 77 for modulating a light so as to provide a light representing an image. As shown in FIG. 2, each modulation optical system 77 is composed of a transmission type liquid crystal display panel (LCD panel) 77a, of which a polarizing plate 77b arranged on an incident side, and a polarizing plate 77c arranged on an emission side.

A predetermined linear polarized light is given to the LCD panel 77a, which allows the light to transmit, whereas partially rotates a polarized surface by 90 degrees by means of the displayed image so as to modulate the light. The modulated light includes a linear polarized light representing the image and an unnecessary linear polarized light, and the unnecessary polarized light is removed by the polarizing plate 77c on the emission side. The polarizing plate 77b on the incident side removes a different polarized component of the polarized surface in order to allow only the predetermined linear polarized light to enter the LCD panel 77a.

Different color lights are given respectively to the three modulation optical systems 77, and each liquid crystal panel 77a displays an image of a color component corresponding to the given color light.

The projector 7 has the light source 71 and the modulation optical systems 77 and also an integrator optical system 72, a polarization converting optical system 73, a color decomposing optical system 74, a light guiding optical system 75, a relay optical system 76, a synthesizing optical system 78 and a projecting optical system 79. The integrator optical system 72, the polarization converting optical system 73, the color decomposing optical system 74, the light guiding optical system 75 and the relay optical system 76 form an illumination optical system.

The integrator optical system 72 is composed of two lens arrays 72a and 72b, and a superimposing lens 72c, and it changes a non-uniform intensity distribution of the light from the light source 71 into an uniform intensity distribution so as to guide the light to the LCD panel 77a.

The lens array 72a separates a light flux from the light source 71 into a plurality of light fluxes so as to use the respective light fluxes as a converged light. The lens array 72b is arranged in a vicinity of a converging position of the respective light fluxes by means of the lens array 72a, and with the superimposing lens 72c, the respective light fluxes are guided to the entire surfaces of the respective LCD panels 77a.

As a result, a center one and a peripheral one of the light fluxes from the light source 71 are superimposed on each other on same LCD panel 77a so that the light intensity distributions on the respective liquid crystal panels 77a become uniform.

The polarization converting optical system 73 converts a non-polarized light from the light-source 71 into a linear polarized light of which all polarized surfaces are arranged uniformly. The polarization converting optical system 73 is composed of a right-angle prism 73a and a parallel flat plate 73b which are jointed together, a polarization separating film 73c which is provided on their jointed surface, a reflection surface 73d which is provided on a surface of the parallel flat plate 73b, and a half-wave plate or film 73e which is provided on the lens array 72b.

The polarization separating film 73c transmits a P-polarized light and reflects a S-polarized light, and the reflection surface 73d entirely reflects a P polarized light which transmits through the polarization separating film 73c and allows the P-polarized light to advance parallel with the S polarized light reflected by the polarization separating film 73c.

The half-wave plate 73e is arranged on one of optical paths of the S polarized light reflected by the polarization separating film 73c and the P-polarized light reflected by the reflection surface 73d, and a polarized surface of the light to be transmitted is rotated by 90 degrees. As a result, the light from the light source 71 becomes a linear polarized light of which all polarized surfaces are arranged uniformly. In addition, the polarizing plate 77b which is positioned on the incident side of the liquid crystal panel 77a is set so as to allow the linear polarized light to transmit.

The color decomposing optical system 74 is composed of two dichroic mirrors 74a and 74b, and decomposes the white light from the light source 71 which passes through the integrator optical system 72 and the polarization converting optical system 73 into a R light, a G light and a B light. For example as shown in the drawings, the dichroic mirror 74a is set so as to allow the R light to transmit and reflect the G light and the B light, and the dichroic mirror 74b is set so as to reflect the G light and allow the B light to transmit.

The light guiding optical system 75 guides the three color lights decomposed by the color decomposing optical system 74 to the three modulation optical systems 77, and allows the guided lights to enter the respective LCD panels 77a approximately vertically. The light guiding optical system 75 is composed of a mirror 75a for reflecting a light which transmits through the dichroic mirror 74a, two mirrors 75b and 75c for reflecting the light which is reflected by the dichroic mirror 74a and transmits through the dichroic mirror 74b, and three field lenses 75d which are arranged on just the front sides of the respective modulation optical systems 77.

An optical path length of the color light which transmits the dichroic mirror 74a and is reflected by the mirror 75a so as to reach one modulation optical system 77 is equal with an optical path length of the color light which is reflected by the dichroic mirror 74a and by the dichroic mirror 74b so as to reach another modulation optical system 77. Moreover, an optical path length of the color light which is reflected by the dichroic mirror 74a and transmits through the dichroic mirror 74b and is reflected by the mirrors 75b and 75c so as to reach the last modulation optical system 77 is longer than the other optical path lengths of the color lights.

The relay optical system 76 is composed of two relay lenses 76a and 76b, and relays an image which is formed on the optical path by the color light which transmits through the dichroic mirror 74b so as to correct a difference in the optical path lengths of the color lights and others color lights. In the three field lenses 75d, one which is arranged on the optical path of the color light via the relay optical system 76 is designed slightly differently from the other two lenses, herewith, the R light, the G light and the B light which enter the three liquid crystal panels 77a respectively become equivalent with one another.

The synthesizing optical system 78 is composed of a cross prism 78a which is provided with dichroic films 78b and 78c on its jointed surfaces, and synthesizes the R light, the G light and the B light which are modulated by the three modulation optical systems 77 respectively so as to represent the image. For example, the dichroic film 78b is set so as to reflect the R light and allow the G light and the B light to transmit, and the dichroic film 78c is set so as to reflect the B light and allow the R light and the G light to transmit.

The projecting optical system 79 projects the synthesized R, G and B lights so as to form an image on a screen. As a result, the color image is displayed on the screen.

The above-mentioned various optical members concern themselves with a light and thus generate a heat so that the temperatures rise, but a degree of the rise of the temperature is different for each optical member. For example, the lamp 71a which generates a heat according to light emission and the reflector 71b which is positioned in its vicinity have high temperature particularly easily, and the UV/IR cut filter 71c for absorbing an ultraviolet light and an infrared light, the LCD panel 77a for modulating a light, and the deflecting plate 77c for absorbing an unnecessary modulated light have also high temperature easily.

In the projector 7 of this embodiment, the members of which temperature becomes high easily are cooled, but the cooling utilizes absorption of heat at the time a liquid is vaporized. Particularly, a liquid is brought into a droplet state or a mist state (this is called as droplet) where the liquid is easily vaporized. Since the liquid is vaporized starting with its surface except the time of boiling, as the surface area is larger, the vaporization proceeds faster.

Moreover, although a volume of a sphere is proportional to the cube of a diameter, the surface area is proportional to the square of the diameter, hence, a ratio of the surface area to the volume is reversely proportional to the diameter. Therefore, in the case the same amount of liquids are vaporized, it is advantageous that the droplets have a small diameter since a total sum of the surface areas is large.

Due to the above-mentioned reason, in the projector 7, a liquid is a droplet and its diameter is not more than 1.5 mm. Although the diameter of the droplet may be larger than 1.5 mm, but in case that the diameter is not more than 1.5 mm, the vaporization can proceed fast. Although the droplet may be as small as possible, its diameter naturally has a lower limit due to a size and cohesion of molecules composing the droplet. As for small molecules of water or the like, a diameter of the aggregation of molecules capable of existing in the droplet is about 1 nm.

A substance of the droplet is not limited, but a substance which has a low boiling point and is easily vaporized and has a high heat of vaporization is preferable. More concretely, a substance in which the boiling point is about 40 to 120 centigrade degrees under air pressure of 1 and the heat of vaporization is about 25 kJ/mol is suitable.

Examples of such a substance is water (boiling point: 100 centigrade degrees, heat of vaporization: 40.7 kJ/mol), ethyl alcohol (boiling point: 78.3 centigrade degrees, heat of vaporization: 38.6 kJ/mol) chloroform (boiling point: 61.2 centigrade degrees, heat of vaporization: 29.4 kJ/mol), acetone (boiling point: 56.3 centigrade degrees, heat of vaporization: 29.0 kJ/mol) and the like.

There will be explained below structures of droplet generating apparatus for generating droplets with reference to FIGS. 3 to 7. In the following drawings, a white arrow D shows a flow of droplet or liquid, and a black arrow A shows a flow of air.

A droplet generating apparatus 1 in FIG. 3 is composed of a drum-shaped container 11 having small opening 11a on its end, for housing a liquid L to be a droplet, a pipe 12 for supplying the liquid L to the container 11, a valve 13 for opening and closing the pipe 12, and a piezoelectric element 14 which is provided inside the container 11 and of which volume changes according to an applied voltage. The container 11 is filled with the liquid L and no air exist inside of it.

In this state, when a voltage is applied to the piezoelectric element 14 and the volume is increased fast, the liquid L of which amount is accordance with the change in the volume ejects from the opening 11a so as to become droplets. At this time, the opening 11a serves as a nozzle. While the volume of the piezoelectric element 14 is being increased, the valve 13 is closed, and when the volume is decreased, the valve 13 is opened so as to replenish the liquid L by an ejected amount.

A droplet generating apparatus 2 of FIG. 4 has a heater 15 instead of the piezoelectric element 14. In the droplet generating apparatus 2, when the heater 15 is electrified and a part of the liquid L is made to be bubbles so that the volume is increased fast, the liquid L is made to be droplets so as to be ejected.

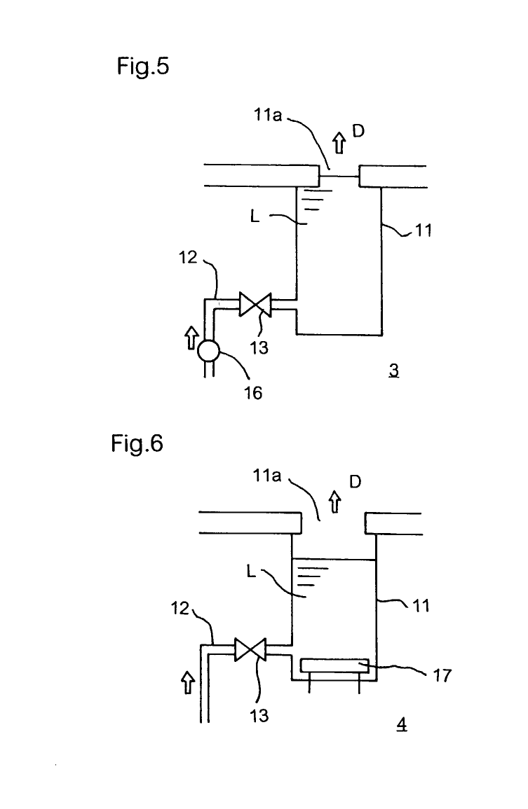

A droplet generating apparatus 3 of FIG. 5 has a micropump 16 in the middle of the pipe in a state where the piezoelectric element 14 and the heater 15 are omitted. In the state where the valve 13 is opened, the inside of the container 11 is pressurized by the micropump 16, so that the liquid L is ejected to be droplets.

In a droplet generating apparatus 4 of FIG. 6, the opening 11a is enlarged, and an ultrasonic vibrator 17 is provided inside the container 11. In the droplet generating apparatus 4, the container 11 is not filled with the liquid L, and a space is allowed to exist on a portion near the opening 11a. In this state, the liquid L is vibrated by the ultrasonic vibrator 17, and the droplets are allowed to scatter from the surface. The scattering droplets pass through the opening 11a so as to come out of the container 11.

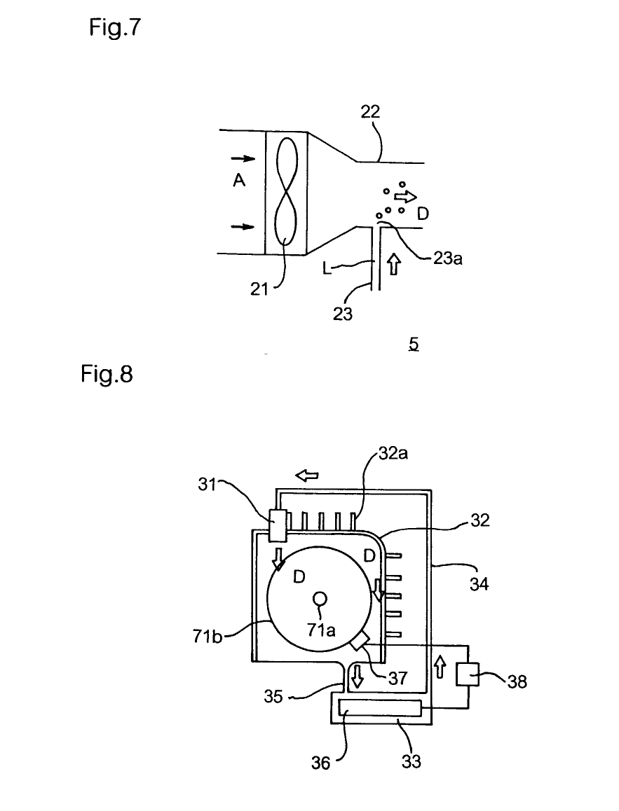

A droplet generating apparatus 5 of FIG. 7 is composed of a small fan 21 for generating an air flow A, a duct 22 for narrowing an air flow path so as to increase a flow rate, and a pipe 23 connected to the duct 22. The liquid L to be droplets is supplied to the pipe 23, and the state of liquid L reaches an opening 23a of the pipe 23 connected with the duct 22. The air flow A generated by the fan 21 increases the flow rate when the air flow A passes through the duct 22, so that the duct 22 side of the opening 23a is evacuated. As a result, the liquid L in the pipe 23 is sucked out so as to become droplets.

The droplet generating apparatuses 1 to 3 can generate droplets having arbitrary sizes and easily control a number of the droplets generated per unit time. The droplet generating apparatuses 4 and 5 can generate comparatively small droplets of which diameter is not more than dozens μm.

The optical members are cooled by droplets according to the following two methods.

(1) The droplets are allowed to adhere to the optical members, so that heat is taken away directly from the optical members.

(2) Cooling air is generated in order to cool the optical members, and the heat of the cooling air is previously taken away by the droplets so that the cooling air has low temperature. The method (1) is a direct one and can obtain high cooling efficiency. The method (2) is an indirect one but can obtain higher cooling efficiency than the case of using only air for cooling.

FIGS. 8 to 11 chemically show examples of the structure for cooling the optical members. FIG. 8 is an example for cooling the reflector 71b of the light source 71 by the method (1). A heat discharging member 32 provided with a lot of fins 32a is arranged around the reflector 71b, and a droplet generating apparatus 31 is arranged above the reflector. As the droplet generating apparatus 31, one of the above-mentioned apparatuses 1 to 5 is used.

A tank 33 for supplying a liquid to the droplet generating apparatus 31 is arranged below the reflector 71b. The tank 33 is connected with the droplet generating apparatus 31 by a pipe 34 and is connected with a bottom face of the heat discharging member 32 by a pipe 35. The pipe 34 is for supplying a liquid, and the pipe 35 is for collecting liquid.

A temperature adjusting apparatus 36 for adjusting temperature of the liquid is provided to the tank 33.

The temperature adjusting apparatus 36 can heat and also cool the liquid in the tank 33. A temperature sensor 37 is attached to the reflector 71b. Moreover, a control apparatus 38 for controlling an operation relating to the cooling is provided to the projector 1. The control apparatus 38 controls operations of the piezoelectric element 14, the heater 15, the valve 13 and the like and also controls the temperature adjusting apparatus 36 according to temperature detected by the temperature sensor 37.

The droplets generated by the droplet generating apparatus 31 drop due to gravity and adhere to the reflector 71b. The droplets take away heat from the reflector 71b so as to be vaporized fast, and cool the reflector 71b. The components of the droplets which become gas contact with the heat discharging member 32 and condense into the liquid. The condensed liquid goes along a side face of the heat discharging member 32 so as to reach its bottom face, and passes through the pipe 35 so as to be collected into the tank 33. The collected liquid is supplied via the pipe 34 to the droplet generating apparatus 31, and is reused for generating droplets.

When the reflector 71b is cooled, the temperature of its inside, namely, the periphery of the lamp 71a is also lowered. As a result, the heat discharge from the lamp 71a is improved, and the lamp 71a is also cooled.

The control apparatus 38 adjusts an amount of droplets to be generated by the droplet generating apparatus 3 according to the temperature detected by the sensor 37 so that all the droplets which adhere to the reflector 71b are vaporized. As a result, very high cooling efficiency can be maintained. If an amount of droplets to be generated is maximum, when the temperature of the reflector 71b exceeds a predetermined value, the control apparatus 38 cools the liquid in the tank 33 via the temperature adjusting apparatus 36 so as to lower the temperature of droplets to be generated.

Generally, as the temperature is lower, the vaporizing heat of the liquid becomes higher, so that the cooling efficiency can be improved by lowering the temperature of droplets. For example in the case of water, the heat of vaporization obtains the above-mentioned value of 40.7 kJ/mol at 100 centigrade degrees, but the heat of vaporization is 45.0 kJ/mol at 0 centigrade degrees, namely, that lowering the temperature of the droplets to be generated means that the cooling efficiency is improved by about 10 percent maximally.

In the droplet generating apparatus 4 of FIG. 6 for generating droplets by means of ultrasonic vibration, as the temperature of the liquid is higher, molecule motion becomes active, and thus an amount of the droplets to be generated is increased. Therefore, in the case where the apparatus 4 is used as the droplet generating apparatus 31, the control apparatus 38 raise the temperature of the liquid in the tank 33 so as to increase an amount of the droplets and heighten the cooling efficiency.

In this case, the cooling effect is lowered by lowering of the heat of vaporization due to the rise in the temperature, but whereas the cooling effect is raised by the increase in an amount of the droplets to be generated, and thus the latter one is larger than the former one.

When the temperature, which is detected by the sensor 37 at the time of starting the control, is high, the control apparatus 38 does not allow a lot of droplets to be generated, but increases an amount of the droplets gradually so as to heighten the cooling efficiency. As a result, this prevents the reflector 71b from being damaged due to abrupt cooling.

When an amount of droplets generated by the droplet generating apparatus 31 is too large, not all the droplets which adhere to the reflector 71b are vaporized, and some of them cohere on the reflector 71b so as to drop from its lower end along the surface. Also in this case, since a heat capacity of the liquid is larger than that of air, the high cooling efficiency can be maintained. Moreover, the droplets cohere on the reflector 71b when the temperature of the reflector 71b is not that high, and thus if such a situation occurs, no problem arises.

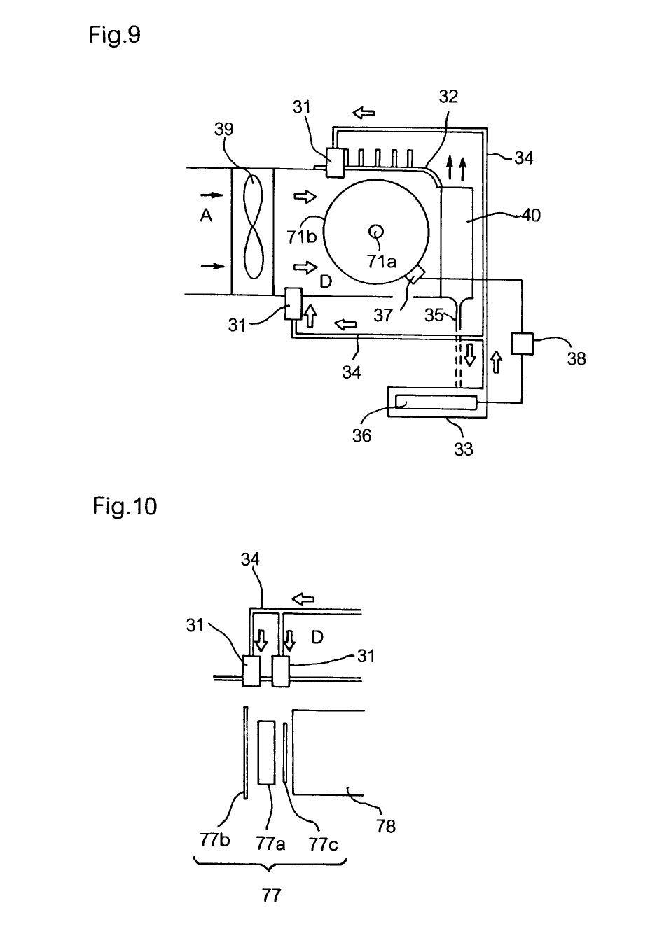

FIG. 9 is also an example for cooling the reflector 71b. The difference from the example in FIG. 8 is that another droplet generating apparatus 31 is added, and a fan 39 and a vapor-liquid separating apparatus 40 are provided. The added droplet generating apparatus 31 is provided on a bottom face of the heat discharging member 32, and droplets generated by the droplet generating apparatus 31 are transferred by the air flow A generated by the fan 39 so as to adhere to the reflector 71b.

The droplets which adhere to the reflector 71b are subject to the air flow generated by the fan 39 and the separation of the molecules from the surface of the droplets is accelerated. Namely, the air flow A accelerates the vaporization of the droplets. Therefore, in this structure, the cooling efficiency is higher than the structure of FIG. 8.

The air flow A generated by the fan 39 serves also as cooling air for cooling the reflector 71b, but since the heat of vaporization of the liquid is 100 times as large as the heat capacity of the air, i.e. vapor, the ratio that the air flow A contributes to the cooling of the reflector 71b is very small. The air flow only transfers the droplets and accelerates the vaporization, and its flow rate may be not large. That is, it is sufficient that a small fan is provided as the fan 39.

The vapor-liquid separating apparatus 40 separates vaporized droplet components, droplets which has been separated from the reflector 71b and droplets which has not adhered to the reflector 71b from air. As the vapor-liquid separating apparatus 40, for example, a revolution or rotational type vapor-liquid separator, in which air flow is turning and allows the molecules which easily cohere by means of a centrifugal force and droplets to adhere to a wall surface so as to separate them, can be used. A mechanism for cooling air, such as a metal plate to which a Peltier Device is attached is provided so that the cohesion of the vaporized components may be accelerated. The liquid separated from the air is collected via the pipe 35 into the tank 33.

FIG. 10 is an example for cooling the liquid crystal panel 77a, and the polarizing plates 77b and 77c of the modulation optical system 77. The cooling method is the same as that in the example of FIG. 8, and the overlapped explanation will be omitted.

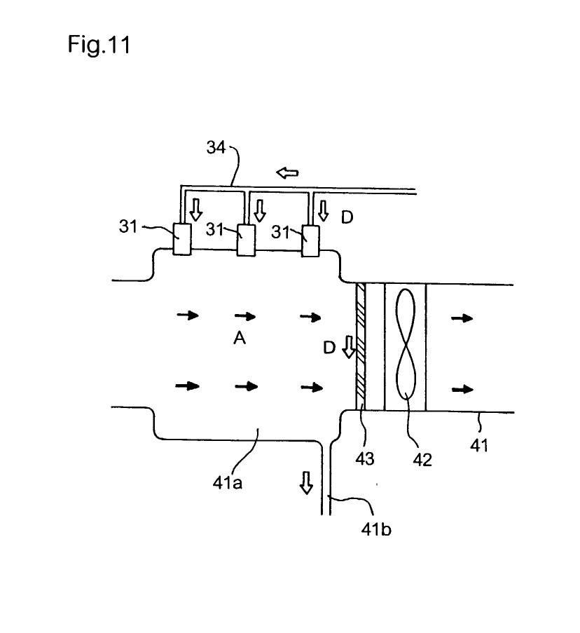

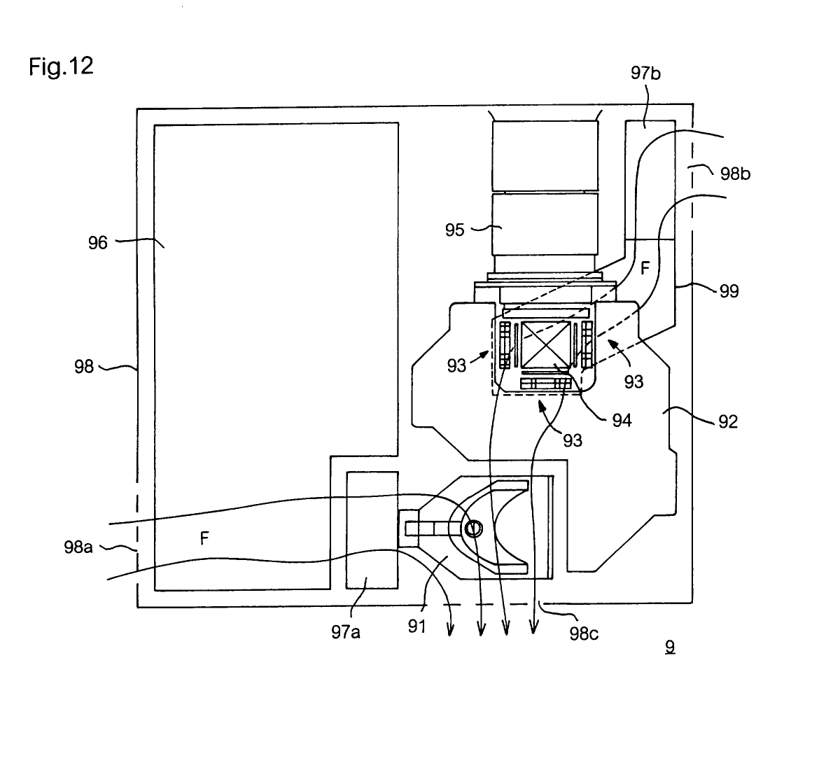

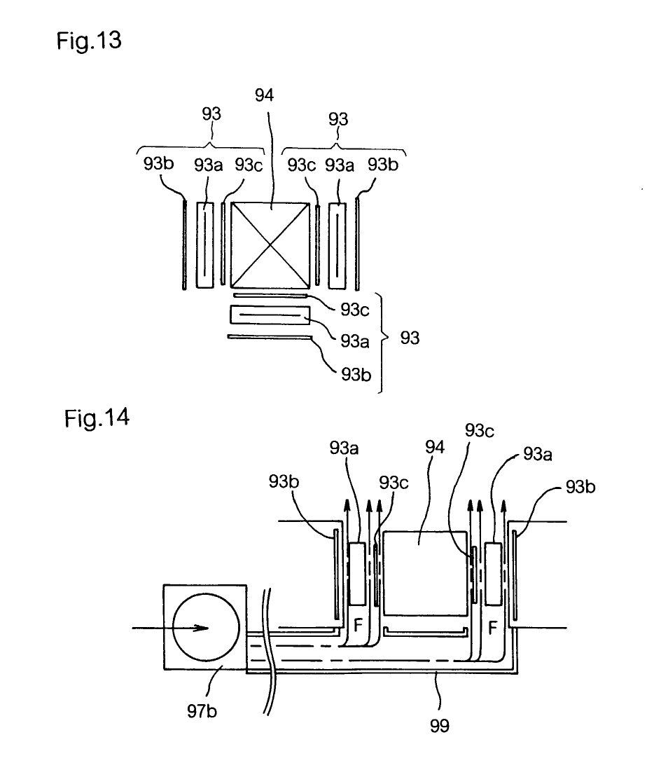

FIG. 11 is an example of the above-mentioned method (2) which previously lowers the temperature of the cooling air for cooling the optical members by means of the droplets. A fan 42 is arranged in the middle of a duct 41 which is provided in the housing of the projector 1 and extends from the intake port to the vicinity of the optical member to be cooled, and the droplet generating apparatuses 31 are provided on an upper stream side of the fan 42. Moreover, a filter 43 which allows only the gas to pass and captures the droplets is provided between the droplet generating apparatuses 31 and the fan 42.

The fan 42 absorbs external air and generates the air flow A to be cooling air, and the droplet generating apparatuses 31 generates droplets so as to allow the droplets to be included in the cooling air generated by the fan 42. Some of the droplets included in the cooling air are vaporized so that the heat of the cooling air is taken away and the temperature of the cooling air is lowered. After the droplets, which remain in the cooling air of which temperature is lowered, are removed by the filter 43, the cooling air reaches to cool the optical member and thereafter is discharged into the outside.

The droplets which captured by the filter 43 cohere into a liquid, which drops along the filter 43 and is collected via a pipe 41b provided to a lower portion of the duct 41. The collected liquid is supplied via the pipe 34 to the droplet generating apparatus 31 so as to be reused for generating droplets. The filter 43, which captures droplets and allows only gas to pass, can be produced by, for example, a porous waterproofing material.

A portion 41a of which cross section is large is provided to the duct 41, where the droplet generating apparatuses 31 may be arranged. The portion 41a with large cross section becomes an air reservoir, and for example, even when the intake port is clogged and air inhaled from the outside is decreased, this serves as a supply source of air to be the cooling air. Moreover, when the droplet generating apparatuses 31 are arranged on this portion 41a, the temperature of the cooling air can be lowered securely even at that time.

This structure can be applied to the cooling of any optical members of the projector 1 such as the lamp 71a, the reflector 71b and the UV/IR cut filter 71c of the light source 71, the liquid crystals panel 77a and the polarizing plates 77b and 77c of the modulation optical system 77. In this method, since the droplets do not advance onto the optical path, the droplet does not influence a light at all. Therefore, it is particularly suitable for the cooling the modulation optical system 77, which directly influences a quality of an image to be provided.

The fan 42 is for generating the cooling air, but since the temperature of the cooling air is lowered and the cooling efficiency is heightened, a small fan can be used. Here, the droplet generating apparatus 31 and the filer 43 are arranged on the upper stream side of the fan 42, but the droplet generating apparatus 31 and the filer 43 may be arranged on the lower stream side of the fan 42.

As mentioned above, the droplet generating apparatus for generating droplets is provided and concerns itself with a light, and the droplets are allowed to adhere to the optical member of which temperature rises so as to cool the optical member, so that the optical member can be cooled extremely efficiently.

In this case, the cooling air is not always used together, and in the case where the cooling air is used together, an amount of the cooling air can be reduced. Therefore, a sound of the cooling air or a sound of a cooling air generator can be reduced, and thus the projector becomes a less noise one. Moreover, the cooling air generator is not necessary or is miniaturized, so that the miniaturization of the projector is easy.

In addition, the air flow generating apparatus for generating the air flow and blowing it onto the optical member is provided and droplets generated by the droplet generating apparatus are included in the air flow generated by the air flow generating apparatus, so that the droplets are transferred by the air flow and the vaporization of the droplets adhering to the optical member can be accelerated by the air flow.

For this reason, it is not necessary to arrange the droplet generating apparatus in the vicinity of the optical member to be cooled, and thus a degree of design freedom of the projector is increased, and the cooling efficiency of the optical member is further heightened. The air flow serves also as cooling air, but since the cooling is carried out mainly by the droplets, a flow rate of air should not be large. Therefore, a small air flow generating apparatus can be used, and the noise is reduced and the projector becomes small.

In addition, the droplet generating apparatus for generating droplets is provided and the droplets are included in the air flow for cooling and the droplets are removed from the air flow before reaching the optical member, so that the temperature of the air flow, i.e., of the cooling air can be lowered and an amount of the cooling air can be reduced. Therefore, the sound of the cooling air and the sound of the air flow generating apparatus are reduced, so that the projector becomes a less noise one.

Moreover, the air flow generating apparatus becomes small, and the entire projector becomes small. Further, since the droplets do not adhere to the optical member, there is no fear of influence of the droplets upon the light, and thus an image with high quality can be provided securely.

The liquid collecting apparatus for collecting droplets or the components of vaporized droplets is provided, so that scattering of the droplet components to the periphery can be suppressed or prevented, and thus the good use environment can be maintained. Moreover, the collected liquid can be reused for generating droplets, and the frequency of replenishing droplets is lowered or it is not necessary to replenish liquid, so that the usability of the projector becomes good.

The temperature adjusting apparatus for adjusting the temperature of droplets to be generated by the droplet generating apparatus is provided, so that easiness of the vaporization of the droplets can be changed, and thus the cooling efficiency of the optical member can be adjusted. Moreover, the temperature of the liquid is heightened, so that the generation of the droplets becomes easy, and thus a lot of droplets can be generated efficiently.

A diameter of droplets to be generated by the droplet generating apparatus is set to not more than 1.5 mm, so that the vaporization of the droplets can be made to be easy, and thus the high cooling efficiency can be realized securely.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A projector generating and projecting a light representing an image, comprising:
an optical member; and
a droplet generator which generates droplets for cooling the optical member.

2. A projector according to claim 1 further comprising an air flow generator which generates an air flow to blow onto the optical member so that the droplets generated by the droplet generator are included in the air flow generated by the air flow generator.

3. A projector according to claim 1 further comprising a liquid collector which collects the droplets or components of vaporized droplets.

4. A projector according to claim 1 further comprising a temperature adjuster which adjusts a temperature of the droplets generated by the droplet generator.

5. A projector according to claim 1, wherein the droplet generator generates droplets of which diameter is not more than 1.5 mm.

6. A projector generating and projecting a light representing an image, comprising:
an air flow generator which generates an air flow inside the projector;
a droplet generator which generates droplets so that the droplets are included in the air flow; and
a droplets remover which removes droplets from the air flow included therein.

7. A projector according to claim 6, wherein the droplets are removed from the air flow before reaching an optical member in the projector.

8. A projector according to claim 6 further comprising a liquid collector which collects the droplets or components of vaporized droplets.

9. A projector according to claim 6 further comprising a temperature adjuster which adjusts a temperature of the droplets generated by the droplet generator.

10. A projector according to claim 6, wherein the droplets generator generates droplets of which diameter is not more than 1.5 mm.
